(19) United States
(12) Patent Application Publication
(10) Pub. No.: US 2020/0264592 A1
(43) Pub. Date: Aug. 20, 2020

(54) SMARTWATCH AND METHOD FOR THE MAINTENANCE OPERATING AN AUTOMATION TECHNOLOGY FACILITY

(71) Applicant: Endress+Hauser Process Solutions AG, Reinach (CH)

(72) Inventor: David Sutter, Michelbach-Le-Haut (FR)

(21) Appl. No.: 16/753,980

(22) PCT Filed: Sep. 11, 2018
(86) PCT No.: PCT/EP2018/074478

§ 371 Date: Apr. 6, 2020

(30) Foreign Application Priority Data
Oct. 6, 2017 (DE) 10 2017 123 225.7

(51) Int. Cl. G05B 19/418; G06K 7/10; G01S 5/02; G04G 21/04; H04B 1/3827; H04W 4/80; H04W 4/02; H04W 4/38

(52) U.S. Cl. CPC G05B 19/41835; G06K 7/10297; G01S 5/0221; G04G 21/04; H04W 84/12; H04W 4/80; H04W 4/023; H04W 4/38; G05B 2219/31368; H04B 1/385

(57) ABSTRACT

The invention relates to a smartwatch having a transmitter/receiver unit and a display unit, wherein the smartwatch is configured for receiving diagnosis notifications of a plurality of automation technology field devices by means of the transmitter/receiver unit, for analysing the received diagnosis notifications and classifying same in predefined device statuses, in particular in device statuses according to the NAMUR recommendation, as well as for displaying the classified device statuses of the field devices by means of the display unit. The invention also relates to a method for maintaining an automation technology system, in which a plurality of field devices are integrated, by means of a smartwatch according to the invention.

The invention relates to a smartwatch. The invention further relates to a method for maintaining an automation technology system by means of a smartwatch according to the invention.

Field devices that are used in industrial facilities are already known from the prior art. Field devices are often used in automation engineering as well as in manufacturing automation. Field devices, in general, refer to all devices which are process-oriented and which supply or process process-relevant information. Field devices are thus used Sepfor detecting and/or influencing process variables. Sensor systems are used for detecting process variables. These are used, for example, for pressure and temperature measurement, conductivity measurement, flow measurement, pH measurement, fill-level measurement, etc. and detect the corresponding process variables of pressure, temperature, conductivity, pH value, fill-level, flow, etc. Actuator systems are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

A variety of such field devices is produced and marketed by the Endress+Hauser group.

In modern industrial plants, field devices are usually connected to superordinate units via communication networks such as fieldbuses (Profibus®, Foundation® Fieldbus, HART®, etc.). The superordinate units are control units, such as an SPS (storage programmable controller) or a PLC (programmable logic controller). The superordinate units are used for process control as well as for commissioning the field devices, among other things. The measured values detected by the field devices, especially, by sensors, are transmitted via the respective bus system to a (or possibly several) superordinate unit(s) that further process the measured values, as appropriate, and relay them to the control station of the installation. The control station serves for process visualization, process monitoring, and process control via the superordinate units. In addition, data transmission from the superordinate unit via the bus system to the field devices is also required, especially for configuration and parameterization of field devices and for controlling actuators.

In the event of an error occurring at the field device, it creates a diagnosis notification which is received in the control center. Depending on the type of error that has occurred, a service technician is charged with correcting the problem that has occurred at the field device. Sometimes there is a large time interval between when the error occurs and when the error is corrected at the field device. Especially in critical cases, however, it is essential to keep this time period as short as possible.

On the basis of this problem, the object of the invention is to provide a device and a method which allow an operator to be informed directly of a diagnosis case of a field device that has occurred.

With regard to the device, the object is solved by a smartwatch having a transmitter/receiver unit and a display unit, wherein the smartwatch is designed to receive diagnosis notifications of a plurality of automation technology field devices by means of the transmitter/receiver unit, to analyze the received diagnosis notifications and classify them into predefined device statuses, especially into device statuses according to the NAMUR recommendation, and to display the classified device statuses of the field devices by means of the display unit.

The great advantage of the invention is that information about a diagnosis case reaches a responsible operator quickly. The operator always wears the smartwatch on his wrist. The individual field devices, or their device statuses, are displayed thereon. At a glance, the operator can see whether all field devices are operating properly or whether there is a diagnosis case. The severity, and thus the urgency for correction, of the diagnosis case is displayed to the operator on the basis of the classified device statuses. The smartwatch does not prevent the operator from executing his typical everyday activities due to the attachment to the wrist and due to the typically small dimensions.

The software required to execute the functionalities, that is to say to receive the diagnosis notifications, to analyze and classify the diagnosis notifications and to display the classified device statuses, can be loaded onto the smartwatch, for example, in the form of an app and executed by the latter.

An operator is, for example, a service technician who executes maintenance work on field devices.

Field devices that are described in connection with the invention are already mentioned by way of example in the introductory part of the description.

According to a preferred embodiment of the smartwatch according to the invention, it is provided that the transmitter/receiver unit is a radio unit according to the NFC/RFID standard, according to the Bluetooth standard or according to the WLAN standard. However, it can also be any other customary radio standard. It is especially advantageous if a radio standard is used which requires little energy.

According to an advantageous development of the smartwatch according to the invention, it is provided that the smartwatch is designed to display only the device statuses of those field devices which are located geographically within a predefined distance from the smartwatch. For the operator, this results in the advantage that, on the one hand, he obtains a better overview, since only a subset of the field devices display their device status. On the other hand, since an affected field device is located in his vicinity, he can quickly and effectively work to correct the problem. In this case, it can be provided, especially in the case of a large automation technology system, to equip a plurality of operators with smartwatches according to the invention and to distribute them in the system. As a result of the resulting allocation of the field devices, an operator can effectively process his “area,” wherein the entire system is covered by the plurality of service technicians.

According to a preferred embodiment of the smartwatch according to the invention, it is provided that the smartwatch has a locating unit for determining the current geographic position of the smartwatch, and

wherein the smartwatch is connected by means of the transmitter/receiver unit to a server which maintains the currently valid location information of the field devices.

According to an advantageous embodiment of the smartwatch according to the invention, it is provided that the smartwatch is designed to compare the signal strength of the transmitted telegrams of the field devices by means of the transmitter/receiver unit and to determine the distance from the smartwatch to the respective field devices via the signal strength.

Field devices are frequently also equipped with radio units in the course of the progressive digitalization with regard to the keywords “Internet of Things (IoT)” and “Industry 4.0,” which also does not stop at components of process systems. In this way, it is possible to retrieve information directly from a field device, or to operate the field device, by means of a smartwatch.

According to a preferred embodiment of the smartwatch according to the invention, it is provided that the smartwatch is designed to transmit identification information of the field devices located within the predefined distance from the smartwatch to a server, wherein the server is designed to identify the respective measurement location of the field devices and at least one further field device associated with the respective measurement location and to notify the smartwatch of the respective measurement location with the corresponding further field device, wherein the smartwatch is designed to receive diagnosis notifications of the further field device and to display the classified device statuses sorted according to the respective measurement location. This is especially useful when a field device of the measurement location is located outside the defined distance but assumes an important role for the functionality of the measurement location. In this way, field devices which do not have a radio unit can also be detected.

According to a preferred embodiment of the smartwatch according to the invention, it is provided that the smartwatch is configurable in such a way that at least one permanent field device is set, the classified device status of which is displayed at all times, irrespective of the distance between the smartwatch and the permanent field device. Critical measurement locations especially can thereby be permanently monitored.

According to a preferred embodiment of the smartwatch according to the invention, is it provided that the smartwatch is designed to output an alarm signal, especially a vibration signal or an acoustic signal, to the wearer of the smartwatch as soon as a defined device status, especially a critical device status, is detected by one of the field devices. An operator is thereby immediately notified of a failure that has occurred. By means of the possibility of setting the defined device status, all of the diagnosis cases that occur, or only those diagnosis cases which endanger the operation of the field device, can lead to an alarm, for example.

According to a preferred embodiment of the smartwatch according to the invention, it is provided that the smartwatch is designed to read out the diagnosis notifications of the field devices directly from the individual field devices by means of the transmitter/receiver unit. It is especially advantageous in this case if the predefined distance of the field devices to be displayed is adapted to the maximum radio link of the smartwatch.

According to a preferred embodiment of the smartwatch according to the invention, it is provided that the smartwatch is designed to read out the diagnosis notifications of the field devices by means of the transmitter/receiver unit from a server which holds the respective diagnosis notifications. This is especially advantageous when the predefined distance of the field devices to be displayed is to exceed the maximum radio link of the smartwatch, or when the majority of the field devices do not have a radio unit. Furthermore, the smartwatch can also be used outside the system according to the invention.

According to a preferred embodiment of the smartwatch according to the invention, it is provided that the smartwatch is designed to compare the classified device statuses which are based on the diagnosis notifications read out directly from the field devices with the classified device statuses which are based on the diagnosis data read out from the server, and in the event of a discrepancy to inform the wearer of the smartwatch about the discrepancy. In this way, it is possible to check the integrity of the data of the transmission link between the field device and the server, or between the field device and the smartwatch.

According to a preferred embodiment of the smartwatch according to the invention, it is provided that the smartwatch is designed to show the classified device statuses as symbols, which symbols differ in shape, color and/or size depending on the device status, wherein the symbols are designed to be selectable and wherein the smartwatch is designed to access the respective field device after selection of one of the symbols and to retrieve further maintenance-relevant information from this field device. It can be provided, for example, that as the criticality of the device statuses increases, the size of the respective symbols increases. It can also be provided to adapt the symbols to the device status symbols of the NAMUR recommendation. After one of the symbols has been selected, the type of diagnosis notification or the content of the diagnosis notification, for example, is displayed. As a result, an operator can already make an initial consideration with regard to the correction measures before even arriving at the affected field device.

According to a preferred embodiment of the smartwatch according to the invention, it is provided that the smartwatch is designed to offer the wearer of the smartwatch further query options which are sent to the field device depending on the received maintenance-relevant information of the field device. These query options are displayed directly to the operator. After a query option has been selected, it is transmitted to the field device. These may be, for example, parameter queries or measured value queries.

Alternatively, it can also be provided that the operator “acknowledges” the request after the repair has been carried out. The control center is then informed of the completed repair.

According to a preferred embodiment of the smartwatch according to the invention, it is provided that the smartwatch is designed to establish a communication connection to a location assigned beforehand to the respective field device, especially a help desk or a service technician, after one of the symbols has been selected. This can be provided, for example, when the operator requires help or the operator is outside the system and cannot immediately reach an affected field device. In the first case, the operator can obtain assistance, for example from the field device manufacturer. In the second case, the operator can inform a service technician currently located in the system, for example.

According to a preferred embodiment of the smartwatch according to the invention, it is provided that the symbols can be selected with one hand, especially by means of the display unit, which contains a touchscreen, and/or by means of a crown attached to the smartwatch and serving as an operating element. By rotating the crown, it is provided that the symbols are selected in sequence. After pressing the crown, the selection is confirmed. By confirming the selection, the further maintenance-relevant information is retrieved or the communication connection to the assigned location is established, for example.

According to a preferred embodiment of the smartwatch according to the invention, it is provided that the smartwatch has sensor elements, especially pressure sensors, humidity sensors, temperature sensors and/or body value sensors, which detect environmental parameters of the smartwatch and/or body functions, especially the blood pressure or the pulse, of the wearer, wherein the smartwatch is designed to determine the environmental parameters and/or body functions at the point in time that a diagnosis notification is received and to link them with the diagnosis data. On the basis of the environmental parameters, for example, a correlation can be established between certain environmental conditions and diagnosis cases that occur. For example, the presence of high humidity could be associated with problems with certain field device types.

Based on the body functions, for example, the degree of stress occurring for the operator can be determined. An increase in the blood pressure and/or the pulse of the operator represents an increase in the stress level of the operator. The values of the body functions are recorded and related to the field devices to generate added value. For example, this added value can be seen in that two identical measurement locations are checked. A higher average stress level of the personnel is registered at one of the measurement locations despite identical maintenance intervals. For example, it can be concluded from this that a more experienced team is used at one of the measurement locations.

The object is further by a method for maintaining an automation technology system, in which a plurality of field devices are integrated, by means of a smartwatch according to the invention, wherein the smartwatch receives diagnosis notifications of a plurality of field devices, analyzes the received diagnosis notifications and classifies them into predefined device statuses, especially into device statuses according to the NAMUR recommendation, and displays the classified device statuses of the field devices.

The invention is explained in greater detail with reference to the following figures. The following is shown:

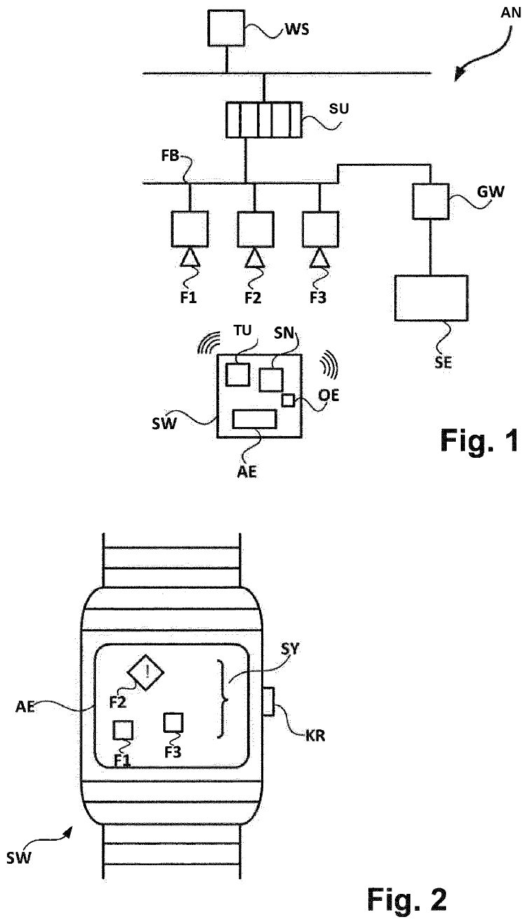

FIG. 1: an exemplary embodiment of the method according to the invention; and

FIG. 2: an exemplary embodiment of the representation function of the smartwatch according to the invention.

FIG. 1 shows an exemplary embodiment of the method according to the invention. In this case, a process automation system AN is shown in which three field devices F1, F2, F3 are integrated. The field devices F1, F2, F3 are in communication with a superordinate unit SU, for example a PLC or a remote I/O, via a fieldbus FB. The superordinate unit itself is connected by means of an industrial Ethernet network to the control room of the system AN, which for example comprises a workstation PC WS for controlling and/or managing the field devices F1, F2, F3.

Furthermore, the fieldbus FB is in communication with a gateway GW. This gateway GW has access to the data traffic transmitted via the fieldbus FB and transmits the accessed data, for example measured values and/or diagnosis notifications of the field devices F1, F2, F3, to a server SE. A plant asset management application, for example, is implemented on the server SE.

If an error occurs in a field device F1, F2, F3, it creates a diagnosis notification. This diagnosis notification is forwarded to the control room, wherein a service technician is then informed and is ordered to correct the problem at the affected field device F1, F2, F3.

To accelerate this process, an operator who is already in the system AN can use a smartwatch SW. This offers the possibility of directly informing the operator about the device status of the field devices F1, F2, F3. For this purpose, the smartwatch SW has a transmitter/receiver unit TU which is used for retrieving diagnosis notifications of the field devices F1, F2, F3. The transmitter/receiver unit uses the radio standard Bluetooth LE, for example.

In principle, two methods are available for retrieving the diagnosis notifications. In a first variant, the smartwatch SW connects directly to the field devices F1, F2, F3 by means of the transmitter/receiver unit TU. The field devices F1, F2, F3 themselves have a radio unit for this purpose. This is especially not the main communication interface of the respective field device F1, F2, F3 but a communication interface for establishing an additional communication channel. After the connection has been established, the smartwatch SW retrieves said diagnosis notifications from the field devices F1, F2, F3 at regular time intervals.

In a second variant, the smartwatch SW connects to the server SE. It can be provided here for the smartwatch SW to directly contact the server SE by means of the transmitter/receiver unit TU, or to contact it indirectly, for example via an access to the gateway GW. Alternatively, the smartwatch SW can also access the server SE via the Internet by means of an additional radio module. After the connection has been established, the smartwatch SW retrieves said diagnosis notifications of the field devices F1, F2, F3 from the server SE at regular time intervals. For retrieval via the Internet, the operator does not have to be in the system.

Alternatively, the smartwatch SW is designed to receive the diagnosis notifications simultaneously by means of both variants. The smartwatch SW then checks the received data against each other and outputs an alarm in case of a discrepancy between the received data from the server SE and the data received directly from the field devices F1, F2, F3.

The retrieved diagnosis notifications are analyzed by the smartwatch SW and classified into different device statuses. For example, the classification is performed using the NAMUR recommendation. The classified device statuses are then displayed on a display unit AE of the smartwatch. FIG. 2 shows an example of such a display:

A plurality of symbols SY are shown on the display unit AE of the smartwatch. Each symbol SY corresponds to a field device F1, F2, F3. The appearance of the symbols SY, i.e. their shape, color and/or size, is determined by the respective current device status of a field device F1, F2, F3. In the example shown in FIG. 2, no diagnosis notification was received for the field devices F1 and F3; thus field devices F1 and F3 have the device status “normal operation.” The respective symbol SY for the field devices F1 and F3 is therefore displayed inconspicuously. For field device F2, a diagnosis notification was received—the field device F2 receives the device status “malfunction.” The symbol SY for the field device F2 is enlarged, undergoes a change in shape and is arranged prominently on the display unit AE. In addition, the smartwatch outputs an alarm signal, for example in the form of an acoustic signal and/or a vibration signal.

As a result, the operator immediately receives the indication that a malfunction has occurred at the field device F2 and can move directly to it. In order to receive further information about the malfunction in advance, the operator selects the symbol SY of the field device F2. For this purpose, he uses the crown KR of the smartwatch. Then, maintenance-relevant information is retrieved from the field device F2 and displayed on the display unit AE of the smartwatch SW. In the event that the operator is not in the system and has retrieved the diagnosis notifications via the Internet, he can inform a location assigned to the field device F2, for example a service technician currently located in the system, by selecting the symbol SY of the field device F2.

In a system AN in which a plurality of field devices F1, F2, F3 are located, the display of the symbols SY assigned to the field devices F1, F2, F3 may become unclear in certain circumstances. The smartwatch SW therefore offers the possibility to display only those field devices F1, F2, F3 which are located within a defined distance from the smartwatch SW. In this case, it can be provided that the symbols of the field devices F1, F2, F3 which are located outside of the distance are only hidden. However, it can also be provided that only the diagnosis notifications of those field devices F1, F2, F3 which are located within the distance are retrieved at all. In both cases, it is possible to determine so-called permanent field devices, the device status of which is constantly displayed irrespective of the distance of the field device F1, F2, F3 from the smartwatch SW. Since the transmitter/receiver unit TU of the smartwatch SW has a finite radio range in certain circumstances, it can be provided to adapt the distance to the radio range of the transmitter/receiver unit TU.

Alternatively, in the case where a plurality of field devices F1, F2, F3 are to be shown, the symbols may be shown as points on the smartwatch. The device status is shown here as a color. As the number of field devices F1, F2, F3 increases, the points are displayed smaller. However, as a result of the color coding of the device statuses, it can be seen whether, for example, a color/device status has proven dominant, which can indicate the general state of the system.

To determine the distance, the smartwatch has a locating unit OE, for example a GPS module. The current location position is transmitted to the server SE, wherein the server holds the location information of all the field devices. The server SE then sends to the smartwatch a list of all the field devices F1, F2, F3 which are located within the distance.

Alternatively, the smartwatch determines the distance to the field devices F1, F2, F3 by means of the transmitter/receiver unit via the signal strength of the transmitted Bluetooth telegrams of the individual field devices F1, F2, F3.

The smartwatch SW according to the invention allows the operator to view the status of the field devices F1, F2, F3 at a glance. The severity of the diagnosis case, and thus the urgency for correcting it, is displayed to the operator on the basis of the classified device statuses. Due to the typically small dimensions of the smartwatch, this is a convenient method; the operator is not prevented from executing his typical everyday activities.

### LIST OF REFERENCE SYMBOLS

AE Display unit
AN System
F1, F2, F3 Field device
FB Fieldbus
GW Gateway
KR Crown
OR Locating unit
TU Transmitter/receiver unit
SR Server
SW Smartwatch
SY Symbols
SU Superordinate unit
WS Workstation PC

1-17. (canceled)

18. A smartwatch, comprising:
a transmitter/receiver unit; and
a display unit,
wherein the smartwatch is designed to receive diagnosis notifications of a plurality of automation technology field devices via the transmitter/receiver unit, to analyze the received diagnosis notifications, to classify the received diagnosis notifications into predefined device statuses, and to display the classified device statuses of the plurality of field devices via the display unit.

19. The smartwatch according to claim 18,
wherein the transmitter/receiver unit is a radio unit according to the NFC/RFID standard, according to the Bluetooth standard, or according to the WLAN standard.

20. The smartwatch according to claim 18,
wherein the smartwatch is designed to display only the device statuses of those field devices of the plurality of field devices that are located geographically within a predefined distance from the smartwatch.

21. The smartwatch according to claim 20, further comprising:
a locating unit for determining the current geographic position of the smartwatch,
wherein the smartwatch is connected via the transmitter/receiver unit to a server which holds the currently valid location information of the plurality of field devices.

22. The smartwatch according to claim 20, wherein the smartwatch is designed to compare a signal strength of the transmitted telegrams of the plurality of field devices using the transmitter/receiver unit and to determine the distance from the smartwatch to the each of the plurality of field devices via the signal strength.

23. The smartwatch according to claim 22, wherein the smartwatch is designed to transmit to a server identification information of a field device of the plurality of field devices located within the predefined distance from the smartwatch, wherein the server is designed to identify the respective measurement location of the field device and at least one further field device associated with the respective measurement location and notify the smartwatch of the respective measurement location with the corresponding further field device, wherein the smartwatch is designed to receive diagnosis notifications of the further field device and to display the classified device statuses sorted according to the respective measurement location.

24. The smartwatch according to claim 18, wherein the smartwatch is configurable in such a way that at least one permanent field device is set, the classified device status of which is displayed at all times, irrespective of a distance between the smartwatch and the permanent field device.

25. The smartwatch according to claim 18, wherein the smartwatch is designed to output an alarm signal, including a vibration signal or an acoustic signal, to the wearer of the smartwatch as soon as a defined device status is detected by one of the plurality of field devices.

26. The smartwatch according to claim 18, wherein the smartwatch is designed to read out the diagnosis notifications of the field devices directly from the plurality of field devices via the transmitter/receiver unit.

27. The smartwatch according to claim 18, wherein the smartwatch is designed to read out the diagnosis notifications of the plurality of field devices via the transmitter/receiver unit from a server which holds the respective diagnosis notifications.

28. The smartwatch according to claim 26, wherein the smartwatch is designed to compare the classified device statuses which are based on the diagnosis notifications read out directly from the plurality of field devices with the classified device statuses which are based on the diagnosis data read out from the server, and in the event of a discrepancy to inform a wearer of the smartwatch about the discrepancy.

29. The smartwatch according to claim 18, wherein the smartwatch is designed to show the classified device statuses as symbols, which symbols differ in shape, color, and/or size depending on the device status, wherein the symbols are designed to be selectable and wherein the smartwatch is designed to access the respective field device after selection of one of the symbols and to retrieve further maintenance-relevant information from this field device.

30. The smartwatch according to claim 29, wherein the smartwatch is designed to offer a wearer of the smartwatch further query options which are sent to the field device depending on the received maintenance-relevant information of the field device.

31. The smartwatch according to claim 29, wherein the smartwatch is designed to establish, after selection of one of the symbols, a communication connection to a location assigned beforehand to the respective field device, including a help desk or a service technician.

32. The smartwatch according to claim 29, wherein the symbols are selectable with one hand via the display unit, which contains a touchscreen, and/or via a crown attached to the smartwatch that serves as an operating element.

33. The smartwatch according to claim 18, further comprising:
sensor elements, including pressure sensors, humidity sensors, temperature sensors, and/or body value sensors, which detect environmental parameters of the smartwatch and/or body functions, including a blood pressure or a pulse, of a wearer,
wherein the smartwatch is designed to determine the environmental parameters and/or body functions at the point in time at which a diagnosis notification is received and to link them to the diagnosis data.

34. A method for maintaining an automation technology system in which a plurality of field devices is integrated, comprising:
providing a smartwatch, including:
a transmitter/receiver unit; and
a display unit,
wherein the smartwatch is designed to receive diagnosis notifications of a plurality of automation technology field devices via the transmitter/receiver unit, to analyze the received diagnosis notifications, to classify the received diagnosis notifications into predefined device statuses, and to display the classified device statuses of the plurality of field devices via the display unit;
receiving diagnosis notifications of a plurality of field devices using the smartwatch;
analyzing the received diagnosis notifications using the smartwatch;
classifying the received diagnosis notifications into predefined device statuses, including into device statuses according to the NAMUR recommendation; and
displaying the classified device statuses of the field devices.
